(19) United States
(12) Patent Application Publication
(10) Pub. No.: US 2014/0265950 A1
(43) Pub. Date: Sep. 18, 2014

(54) SWITCHED RELUCTANCE MOTOR

(71) Applicant: Cheng Chieh HUNG, Tainan (CN)

(72) Inventor: Cheng Chieh HUNG, Tainan (CN)

(21) Appl. No.: 14/166,833

(22) Filed: Jan. 28, 2014

(30) Foreign Application Priority Data
Mar. 12, 2013 (CN) 102204521

(51) Int. Cl. H02P 25/08; H02K 11/00

(52) U.S. Cl. CPC H02P 25/08; H02K 11/0021
USPC 318/254.1; 310/68 B

(57) ABSTRACT

A switched reluctance motor (SRM) is disclosed which has a rotor position detecting system with magnetic switches to detect the rotor position and give signals to a logic circuit to trigger electrical phase changes among the coils of the switched reluctance motor.

### BACKGROUND

1. Technical Field

The present invention relates to a switched reluctance motor (SRM), especially related to a switched reluctance motor having a rotor position detecting system which has magnetic switches to detect the rotor position and give signals to a logic circuit to trigger electrical phase changes among the coils of the switched reluctance motor.

2. Description of Related Art

FIG. 1 is a prior art

FIG. 1 shows a switched reluctance motor (SRM) disclosed in the WIPO Patent Application WO/2008/035876. FIG. 1 is an exploded perspective view of partial structure of the SRM. The stator poles and rotor poles are housed in a housing P140. A shaft hole P146 is configured on the front end of the housing P140 for the accommodation of a rotary shaft. The rotor poles position detecting unit includes a sensor disk P151 combined at a pre-set position of the rotary shaft 131 at the outer side of the housing P140. Two sensors P160 are set opposite for interacting with the sensor disk P151. The sensor disk P151 is fixed on the rotary shaft and rotates along with the rotation of the rotary shaft. The sensor disk P151 includes a blocking portion P152 and a sensing portion P154 which have respective different lengths along a radial direction, and a shaft hole P153 is penetratingly formed at the center thereof, through which the end portion of the rotary shaft is inserted. The opposite sensors P160 are configured on a sensor support member. A light emitting part P166 that emits light and a light receiving part P167 that receives and senses light irradiated from the light emitting part P166. The light ray irradiated from the light emitting part P166 shall be cut into pieces when the sensor disk P151 rotates along with the rotation of the rotary shaft. Herein, the sensor P160 is formed as a pair in order to detect the rotational position of the rotor poles according to each electrical phase (A and B) of the stator coil. The rotor position detecting system disclosed in the prior art is a mechanical system with a light ray detection. The deficiency is that the prior art system needs a relative expensive processor to process the signals from the paired sensors P160 before generating any electrical phase signals for each of the coils. A simpler structure and more accurate rotor poles position detecting system is desired for cost down for a switched reluctance motor.

### BRIEF DESCRIPTION OF THE DRAWINGS

FIG. 1 is a prior art

FIG. 2 shows a first embodiment according to the present invention.

FIG. 3 shows an electrical system for the first embodiment.

FIG. 4 shows the magnetic switch used in the first embodiment.

FIG. 5 shows a relative position of the switches for the first embodiment.

FIG. 6 shows a timing diagram for the motor of the first embodiment.

FIG. 7 shows an exploded view for the motor of the first embodiment.

FIGS. 8A-8B shows an elevation view of the switching system for the first embodiment.

FIGS. 9A-9B shows a modified switching system for the first embodiment.

FIG. 10 shows a second embodiment according to the present invention.

FIG. 11 shows an electrical system for the second embodiment.

FIG. 12 shows a relative position of the switches for the second embodiment.

FIG. 13 shows a timing diagram for the motor of the second embodiment.

FIGS. 14A-14B shows an elevation view of the switching system for the second embodiment.

FIGS. 15A-15B shows a modified switching system for the second embodiment.

### DETAILED DESCRIPTION OF THE INVENTION

The present invention discloses a switched reluctance motor with magnetic switches and a logic circuit to generate electrical phase signals for controlling each of the coils. The present invention uses a relatively simpler logic circuit to generate electrical phase signals for controlling each of the coils instead of using a relatively expensive processor.

FIG. 2 shows a first embodiment according to the present invention.

FIG. 2 shows a four-phase 8/6 SRM which has eight stator poles and six rotor poles. There are four sets of coils: coil 1, coil 2, coil 3 and, coil 4. Each of the coils is electrically coupled to a logic circuit 14. There are six magnets; each is configured in a position corresponding to one of the six rotor poles. A circuit board 16 is configured on an inner surface of a front cover 114 of the motor 1. Two magnetic switches (or sensors) S1, S2 are configured on the circuit board 16 facing the rotor poles. The switches S1, S2 are electrically coupled to the logic circuit 14. The sensors S1, S2 used in the first embodiment are uni-pole Hall Effect sensors.

FIG. 3 shows an electrical system for the first embodiment.

FIG. 3 shows that a first magnetic switch Si and a second magnetic switch S2 are electrically coupled to a logic circuit 14 for signal processing and then output four electrical phase signals: phase A, phase B, phase C, and phase D. Each of the electrical phase signals represents the ON/OFF status of one of the coils.

FIG. 4 shows the magnetic switch used in the first embodiment.

FIG. 4 shows that each of the magnets 125 rotates along with the rotation of the rotor poles 125. An ON signal shall be generated when one of the magnets 125 approaches each of the magnetic switches S1, S2. An OFF signal shall be generated when one of the magnets 125 departs each of the magnetic switches S1, S2.

FIG. 5 shows a relative position of the switches for the first embodiment.

FIG. 5 shows a central angle of 135 degree configured by the two switches Si and S2 with reference to the center of the rotary shaft 121. The switches S1, S2 are configured on a surface of a circuit board 16 facing the rotor poles 122. The circuit board 16 is configured on an inner surface of a front cover 114 of the motor 1 facing the rotor poles 122. Each of the six magnets 125 is configured in a position corresponding to one of the rotor poles 122. Each of the magnets 125 rotates along with the rotation of the rotor poles 122. The magnetic field of each magnet 125 interacts with each of the switches S1, S2 when passing by each of the switches S1, S2. There are four coils, coil 1˜4, each coil winds opposite ones of the eight stator poles 112. Four electrical phase signals, phase A˜D, are generated from the logic circuit 14 for each of the coils. Each electrical phase represents the ON/OFF status of one of the coils.

FIG. 5 shows a motor which has eight stator poles 112 and four coils, coil 1, coil 2, coil 3, and coil 4. Coil 1 winds a first pair of opposite stator poles 112. Coil 2 winds a second pair of opposite stator poles 112. Coil 3 winds a third pair of opposite stator poles 112. Coil 4 winds a fourth pair of opposite stator poles 112. There are six rotor poles 122 and a rotary shaft 121 surrounded by the stator poles 112. There are six magnets 125; each magnet 125 is configured in a position corresponding to one of the six rotor poles 122. A circuit board 16 is configured on an inner surface of the front cover 114 facing the rotor poles 122.

A first magnetic switch Si is configured on the circuit board 16 at a first position for sensing a first magnetic field of a passing magnet. A second magnetic switch S2 is configured on the circuit board 16 at a second position for sensing a second magnetic field of a passing magnet. A central angle or mechanical angle of 135 degree is exemplified, by the first magnetic switch Si and the second magnetic switch S2 with reference to a center of the rotary shaft 121. According to the first embodiment, the switches Si and S2 is configured with 90 degree electrical angle difference. Because each 120 degree central angle or mechanical angle is a cycle for each 90 degree electrical angle difference, therefore the central angle or mechanical angle between the two switches S1, S2 can be one selected from a group consisting of 15, 75, 135, 195, 255, and 315 degree for the first embodiment.

For an ideal operation according to the first embodiment, a 7.5 degree central angle or mechanical angle prior to the sensor S1, S2 is set to trigger the switch ON; and a 7.5 degree central angle or mechanical angle anterior to the switches S1, S2 is set to trigger the switch OFF. A little later trigging ON or a little earlier triggering OFF can be performed but with a less efficiency for a torque output of the motor.

FIG. 6 shows a timing diagram for the motor of the first embodiment.

FIG. 6 shows the ON/OFF status of each of the switches S1, S2, with reference to the electrical phases for each of the coils. A first ON signal is generated when one of the magnets 125 approaches the first switch Si within a predetermined central angle, say, at 0 and 60 degree mechanical angle. A first OFF signal is generated when one of the magnets 125 departs the first switch Si beyond a predetermined central angle, say, at 30 and 90 degree mechanical angle. A second ON signal is generated when one of the magnets 125 approaches the second switch S2 within a predetermined central angle, say, at 45 degree mechanical angle. A second OFF signal is generated when one of the magnets 125 departs the second switch S2 beyond a predetermined central angle, say, at 75 degree mechanical angle. The bottom line of FIG. 6 shows the Electrical Angle corresponding to each Mechanical Angle.

The first ON/OFF signals and the second ON/OFF signals are sent to a logic circuit 14 for further processing. Four electrical phase signals are generated according to a predetermined logic. A first electrical phase signal, phase A, is generated for the first coil, a second electrical phase signal, phase B, is generated for the second coil, a third electrical phase signal, phase C, is generated for the third coil; and a fourth electrical phase signal, phase D, is generated for the fourth coil.

Referring to FIG. 6, the first electrical phase, phase A, turns on for coil 1 when the first ON signal generated by switch S1. The second electrical phase, phase B, turns on for coil 2 when the second OFF signal generated by switch S2. The third electrical phase, phase C, turns on for coil 3 when the first OFF signal generated by switch S1. The fourth electrical phase, phase D, turns on for coil 4 when the second ON signal generated by switch S1.

The first electrical phase, phase A, turns off for coil 1 when the first OFF signal generated by switch S1. The second electrical phase, phase B, turns off when the second ON signal generated by switch S2. The third electrical phase, phase C, turns off for coil 3 when the first ON signal generated by switch S1. The fourth electrical phase, phase D, turns off for coil 4 when the second OFF signal generated by switch S2. Each of the magnetic switches S1, S2 used in the first embodiment is a unipolar hall sensors

FIG. 7 shows an exploded view for the motor of the first embodiment.

FIG. 7 show that a fixing plate 126 is configured on a front side of the rotor poles 122 and rotates along with the rotor poles 122. Six magnets 125 are prepared; each of the magnets 125 is configured on a front side of the fixing plate 126 facing the circuit board 16, and in a position corresponding to one of the rotor poles 122. A rotary shaft 121 is configured in the center of the rotor poles 122. A bearing 123 is configured on the end of the rotary shaft 121. A back cover 124 is configured on a backside of the rotor poles 122.

FIGS. 8A-8B shows an elevation view of the switching system for the first embodiment. FIG. 8A shows that the magnets 125 is configured on the front side of the fixing plate 126. FIG. 8B shows that the switches S1, S2 are configured on a surface of a circuit board 16 which is configured on an inner surface of the front cover 114.

FIGS. 9A-9B shows a modified switching system for the first embodiment.

FIG. 9A shows that each of the six magnets 125B is configured on the front side of one of the six rotor poles 122 facing the circuit board 16. FIG. 9B shows that the switches S1, S2 are mounted on a circuit board 16 which is fixed on an inner surface of the front cover 114. Each of the switches S1, S2 faces the magnets 125B. Each of the magnets 125B rotates along with the rotation of the rotor poles 122. Each of the magnets 125B interacts with the switches S1, S2 through its magnetic field while passing by the switches S1, S2.

FIG. 10 shows a second embodiment according to the present invention.

FIG. 10 shows a three-phase 12/8 SRM which has twelve stator poles 112 and eight rotor poles 122. There are three sets of coils: coil 1˜3; each of the coils is electrically coupled to a logic circuit 14. There are eight magnets 125C, each is configured in a position corresponding to one of the eight rotor poles facing a circuit board 16. The circuit board 16 is configured on an inner surface of a front cover 114 of the motor 1. Three magnetic switches (or sensors) S1, S2, S3 are configured on the circuit board 16 facing the rotor poles 122. The magnetic switches S1, S2, S3 are electrically coupled to the logic circuit 14.

FIG. 11 shows an electrical system for the second embodiment.

FIG. 11 shows that a first magnetic switch S1, a second magnetic switch S2, and a third magnetic switch S3 are electrically coupled to a logic circuit 14 for signal processing. The logic circuit 14 outputs three electrical phase signals, phase A˜C, according to a predetermined logic, each of the electrical phase signals represents the ON/OFF status of one of the coils.

FIG. 12 shows a relative position of the switches for the second embodiment.

FIG. 12 shows that the SRM has twelve stator poles 112. There are three coils, each coil winds opposite ones of the stator poles 112. There are eight rotor poles 122 and a rotary shaft 121. FIG. 12 shows that a central angle of 30 degree is configured between switches S1 and S2, and between switches S2 and S3, with reference to the center of the rotary shaft 121. Each of the switches S1, S2, S3 is aligned with a central axis of one of the stator poles 112. There are three coils, each coil winds opposite ones of the twelve stator poles 112. Three electrical phase signals are generated from the logic circuit 14 according to a predetermined logic. Each electrical phase represents the ON/OFF status of one of the coils.

FIG. 13 shows a timing diagram for the motor of the second embodiment.

FIG. 13 shows the ON/OFF status of each of the switches S1, S2, S3 with reference to the electrical phases for each of the coils. A first ON signal is generated when one of the magnets 125C approaches the first switch S1 within a predetermined central angle, say, at 15 and 60 degree mechanical angle. A second ON signal is generated when one of the magnets 125C approaches the second switch S2 within a predetermined central angle, say, at 0, 45, and 90 degree mechanical angle. A third ON signal is generated when one of the magnets 125C approaches the third switch S3 within a predetermined central angle, say, at 30 and 75 degree mechanical angle. The bottom line of FIG. 13 shows the Electrical Angle corresponding to each Mechanical Angle.

The first ON signals, the second ON signals, and the third ON signals are sent to a logic circuit 14 for further processing. Three electrical phase signals are generated according to a predetermined logic. A first electrical phase signal, phase A, is generated for the first coil, a second electrical phase signal, phase B, is generated for the second coil, and a third electrical phase signal, phase C, is generated for the third coil. The first electrical phase, phase A, turns on when the first ON signal is generated by the first switch S1. The second electrical phase, phase B, turns on when the second ON signal is generated by the second switch S2. The third electrical phase, phase C, turns on when the third ON signal is generated by the third switch S3. The first electrical phase turns off when the third ON signal is generated by the third switch S3. The second electrical phase turns off when the first ON signal is generated by the first switch S1. The third electrical phase turns off when the second ON signal is generated by the second switch S2.

FIGS. 14A-14B shows an elevation view of the switching system for the second embodiment.

FIG. 14A shows that there are eight magnets 125C, each configured in a position corresponding to one of the eight rotor poles 122. FIG. 14A shows that a fixing plate 126 is configured on the front side of the rotor poles 122. Each of the magnets 125C is configured on a front side of the fixing plate 126 facing the circuit board 16 and in a position corresponding to one of the rotor poles 122.

FIG. 14B shows that three switches S1, S2, S3 configured on a surface of the circuit board 16 facing the rotor poles 122. A first magnetic switch S1 is configured on the circuit board 16 at a first position for sensing a first magnetic field of a passing magnet 125C. A second magnetic switch S2 is configured on the circuit board 16 at a second position for sensing a second magnetic field of a passing magnet 125C. A third magnetic switch S3 is configured on the circuit board 16 at a third position for sensing a third magnetic field of a passing magnet 15C. Each of the magnetic switches S1, S2, and S3 used in the second embodiment is a unipolar hall sensor. FIG. 14B shows that a first central angle formed by the first magnetic switch Si and the second magnetic switch S2 with reference to the center of the rotary shaft 121 is 30 degree. A second central angle formed by the second magnetic switch S2 and the third magnetic switch S3 with reference to the center of the rotary shaft 121 is also 30 degree.

FIGS. 15A-15B shows a modified switching system for the second embodiment.

FIG. 15A shows that each of the eight magnets 125D is configured on the front side of one of the eight rotor poles 122 facing the circuit board 16. FIG. 15B shows that the switches S1, S2, S3 are mounted on a circuit board 16 which is fixed on an inner surface of the front cover 114. Each of the switches S1, S2, S3 faces the magnets 125D. Each of the magnets 125D rotates along with the rotation of the rotor poles 122. Each of the magnets 125D interacts with the switches S1, S2, S3 through its magnetic field while passing by the switches S1, S2, S3.

For an ideal operation according to the second embodiment is that the ON signal is triggered at a position no larger than 3.75 degree central angle or mechanical angle anterior to each of the magnetic switches S1, S2, S3. A little later trigging ON can also be performed but with a less efficiency for a torque output of the motor.

While several embodiments have been described by way of example, it will be apparent to those skilled in the art that various modifications may be configured without departs from the spirit of the present invention. Such modifications are all within the scope of the present invention, as defined by the appended claims.

What is claimed is:

1. A switched reluctance motor, comprising:
eight stator poles;
a first coil, winding a first pair of the stator poles;
a second coil, winding a second pair of the stator poles;
a third coil, winding a third pair of the stator poles;
a fourth coil, winding a fourth pair of the stator poles;
six rotor poles and a rotary shaft;
six magnets, each configured in a position corresponding to one of the six rotor poles;
a circuit board;
a first magnetic switch, configured on the circuit board at a first position for sensing a first magnetic field of a passing magnet;
a second magnetic switch, configured on the circuit board at a second position for sensing a second magnetic field of a passing magnet; and
a central angle formed by the first magnetic switch and the second magnetic switch with reference to a center of the rotary shaft, selected from a group consisting of 15, 75, 135, 195, 255, and 315 degree.

2. A switched reluctance motor as claimed in claim 1, wherein
a first ON signal, being generated when one of the magnets approaches the first switch within a predetermined central angle;
a first OFF signal, being generated when one of the magnets departs the first switch beyond a predetermined central angle;
a second ON signal, being generated when one of the magnets approaches the second switch within a predetermined central angle;
a second OFF signal, being generated when one of the magnets departs the second switch beyond a predetermined central angle;
the first ON/OFF signals and the second ON/OFF signals, being sent to a logic circuit;
a first electrical phase signal, being generated for the first coil;
a second electrical phase signal, being generated for the second coil;
a third electrical phase signal, being generated for the third coil; and
a fourth electrical phase signal, being generated for the fourth coil.

3. A switched reluctance motor as claimed in claim 2, wherein the first electrical phase turns on when the first ON signal generated;
the second electrical phase turns on when the second OFF signal generated;
the third electrical phase turns on when the first OFF signal generated;
the fourth electrical phase turns on when the second ON signal generated;
the first electrical phase turns off when the first OFF signal generated;
the second electrical phase turns off when the second ON signal generated;
the third electrical phase turns off when the first ON signal generated; and
the fourth electrical phase turns off when the second OFF signal is generated.

4. A switched reluctance motor as claimed in claim 1, wherein
the first magnetic switch is a first unipolar hall sensor; and
the second magnetic switch is a second unipolar hall sensor.

5. A switched reluctance motor as claimed in claim 1, further comprising:
a fixing plate, configured on the front side of the rotor poles; wherein
each of the magnets is configured on a front side of the fixing plate, and in a position corresponding to one of the rotor poles.

6. A switched reluctance motor as claimed in claim 1, wherein
each of the magnets is configured on the front side of one of the rotor poles.

7. A switched reluctance motor as claimed in claim 2, wherein
the first ON signal is triggered at a position no larger than 7.5 degree angle anterior to the magnetic switch; and the first OFF signal is triggered at a position no larger than 7.5 degree angle posterior to the magnetic switch; and
the second ON signal is triggered at a position no larger than 7.5 degree angle anterior to the magnetic switch; and the second OFF signal is triggered at a position no larger than 7.5 degree angle posterior to the magnetic switch.

8. A switched reluctance motor, comprising:
twelve stator poles;
a first coil, winding a first pair of the stator poles;
a second coil, winding a second pair of the stator poles;
a third coil, winding a third pair of the stator poles;
eight rotor poles and a rotary shaft;
eight magnets, each configured in a position corresponding to one of the eight rotor poles;
a circuit board;
a first magnetic switch, configured on the circuit board at a first position for sensing a first magnetic field of a passing magnet;
a second magnetic switch, configured on the circuit board at a second position for sensing a second magnetic field of a passing magnet;
a third magnetic switch, configured on the circuit board at a third position for sensing a third magnetic field of a passing magnet.

9. A switched reluctance motor as claimed in claim 8, wherein a first ON signal, being generated when one of the magnets approaches the first switch within a predetermined central angle;
a second ON signal, being generated when one of the magnets approaches the second switch within a predetermined central angle;
a third ON signal, being generated when one of the magnets approaches the third switch within a predetermined central angle;
the first, second, and third ON signals, being sent to a logic circuit;
a first electrical phase signal, being generated for the first coil;
a second electrical phase signal, being generated for the second coil; and
a third electrical phase signal, being generated for the third coil.

10. A switched reluctance motor as claimed in claim 9, wherein
the first electrical phase turns on when the first ON signal generated;
the second electrical phase turns on when the second ON signal generated;
the third electrical phase turns on when the third ON signal generated;
the first electrical phase turns off when the third ON signal generated;
the second electrical phase turns off when the first ON signal generated; and
the third electrical phase turns off when the second ON signal is generated.

11. A switched reluctance motor as claimed in claim 8, wherein
the first magnetic switch is a first unipolar hall sensor;
the second magnetic switch is a second unipolar hall sensor; and
the third magnetic switch is a third unipolar hall sensor.

12. A switched reluctance motor as claimed in claim 8, wherein
a first central angle formed by the first magnetic switch and the second magnetic switch with reference to the center of the rotary shaft is 30 degree; and
a second central angle formed by the second magnetic switch and the third magnetic switch with reference to the center of the rotary shaft is 30 degree.

13. A switched reluctance motor as claimed in claim 8, further comprising:
a fixing plate, configured on the front side of the rotor poles; wherein
each of the magnets is configured on a front side of the fixing plate, and in a position corresponding to one of the rotor poles.

14. A switched reluctance motor as claimed in claim 8, wherein
each of the magnets is configured on the front side of one of the rotor poles.

15. A switched reluctance motor as claimed in claim 9, wherein
the first ON signal is triggered at a position no larger than 3.75 degree angle anterior to the first magnetic switch;
the second ON signal is triggered at a position no larger than 3.75 degree angle anterior to the second magnetic switch; and
the third ON signal is triggered at a position no larger than 3.75 degree angle anterior to the third magnetic switch.
